(19) United States
(12) Patent Application Publication
(10) Pub. No.: US 2012/0117066 A1
(43) Pub. Date: May 10, 2012

(54) Computer implemented method for processing data on an internet-accessible data processing unit

(76) Inventor: FLORIAN GOETTE, MUNCHEN (DE)

(21) Appl. No.: 13/212,444

(22) Filed: Aug. 18, 2011

(30) Foreign Application Priority Data
Aug. 20, 2010 (EP) 10 173 594.2

(51) Int. Cl. G06F 17/30

(52) U.S. Cl. 707/737; 707/781; 707/E17.044

(57) ABSTRACT

Computer implemented method for processing data on a data processing unit accessible through the Internet, in particular for a evaluating and/or updating and/or adapting of data sets which are stored on an Internet-accessible database equipment (10), wherein the data processing unit (10) is designed for access of a plurality of users (18, 22), and wherein due to the limits of the computational capacity, restrictions are existing for the access and wherein, furthermore, an application for processing of data on the data processing unit (10) may be installed which may be used by the users (18, 22), wherein a segmentation of the data to be processed is carried out, characterized in that the segmentation is made such that the resources made available by the data processing unit are predicted for a working step, and that all data contained in the segment, in particular data sets, can be completely processed with the available resources, and that the segment size is anyway selected as large as possible.

This application claims priority of and the benefit of European patent application number: 10 173 594.2, filed on Aug. 20, 2010. European patent application number: 10 173 594.2, filed on Aug. 20, 2010, is hereby incorporated herein in its entirety by reference hereto.

The invention relates to a computer implemented method for processing data from a data processing unit to which a plurality of users has access through the Internet.

Due to the increasing use of the Internet, also the data storage on a, in particular, central data processing unit accessible through the Internet, becomes ever more popular. The data processing unit can also be a system of a data processing unit. There are vendors that put corresponding data processing equipment to disposal and equip it with a platform through which the data stored on the data processing unit are accessible worldwide. These data are preferably managed in database systems. These database systems are for example providing customer—and contact data: In order to use the data from the database system, applications for processing the data can be installed on the platform which is put onto the data processing unit. By means of the application, in general a plurality of users has access to different data which are associated with them. However, individual users have to process a large number of data resulting in a massive data processing effort. In essence, the data to be processed are compared with comparable data and the differences are identified.

Because of the limitation of the resources, restrictions are imposed to the user. These restrictions are based, in the end, on the allocation of the available resources to a user for processing data that are available to the user for the processing. As a rule, exceeding the allocated resources leads to a breakdown of the total processing step which again results in that all data operations in the deleted processing step are cancelled. In this way, a massive data processing is prevented and it is taken care that sufficient resources and response times are provided to each user, and that the data processing unit is not overloaded: For use, the data processing unit provides a platform by which a basic functionality of the platform is given. On this platform, applications can be installed for the data processing by which applications the user can carry out data processing taking into account the restrictions imposed by resources.

The publication “Data cleansing as a transient science”, Tanveer A. Faruqui, et al., IEEE ICDE Conference 2010 discloses a method for processing data on Internet-connected data processing systems.

It is an object of the invention to provide a method which can process a large amount of data within the resources available and which may be designed flexibly with respect to user's requirements. In particular, it should be possible to carry out a consolidation, normalization and duplicate detection on a central data processing unit accessible through the Internet.

In a way known per se, a computer implemented method for processing of data sets comprises a sequential execution of a list of instructions for processing. The data sets are stored on a data processing unit accessible through the Internet. The data processing unit is designed for the access of a plurality of users wherein the resources of the data processing unit is put to the disposal of the users. In the computer implemented method, the instructions for processing of data sets are designed such that the amount of the data sets to be processed is segmented. All data sets of the segment have to be compared to comparable data. The data to be compared are divided up into packets for this purpose wherein all data sets of a packet are compared to all data sets of a segment. The complete amount of the data sets to be processed is divided up into segments, and all data sets to be compared are divided up into packets, whereby the comparison of the segment with a packet is carried out in operational steps spaced in time, After all data sets of a segment have been processed, the next segment, if existing, is compared with the packets of the data sets to be compared. A comparison can be followed by processing a data set.

According to the invention, the size of the packets is adapted to the available resources. Therein, the selection of the packet size and also of the data to be compared is carried out such that all data sets of a segment can be compared with all data sets of a packet with the available resources, and that, in spite of that, the segments and the packets are selected as large as possible.

In this way, a massive data processing in which a plurality of data sets are processed, can be carried out in spite of the restrictedly available resources which can be processed in a comparably short time.

The available resources can be queried, especially in the form of restrictions, for the respective system at run time. The restrictions can vary from one platform version to the next one which is why the invention is flexibly configurable and customizable. Resource restrictions are valid in all fields of the data processing with respect to the number of computational operations, the useable storage, the queried data sets down to the number of processing loops. The resource restrictions are depending on the platform version as well as on the context of the resource request.

Preferably, segment size and packet size are adapted to each other in such a way that a maximum number of data sets can be processed with as few operations as possible.

Preferably, the size of a packet is defined irrespective of the segment size thereby that it is evaluated how many attributes of a data set have be verified. Thereafter, the number of the operations necessary in average, for processing the data sets is predicted. In consideration of the predefined number of operations to be carried out in one time section based on the available resources, the number of the data sets to be processed in one segment is than defined. It has been shown that segment sizes evaluated in this way, can be processed with a very high probability, and that they are, furthermore, large enough such that a fast processing is ensured.

In particular, it is queried at first which parameters are set as boundary conditions for the updating and searching for data sets, for example the setting of the degree of similarity. In this way, the focus can be user specifically adapted. Furthermore, differently optimized presets can be used for special situations, for example for the case of a large number of new data sets or for the case of large amounts of updated data sets.

Differently optimized presets can also be defined according to the kind of processing, for example for the duplicate detection, data consolidation and data normalization. The size of the segments is predetermined as further parameter according to each kind of processing, i.e. how many data sets to be processed are to be processed at maximum within the framework of a batch processing. The upper limit depends on the current restrictions of the platform as well as from the maximum processing steps per each data set.

For each kind processing, the packet size is set as a further parameter, i.e. how many data sets to be compared should be used at maximum in the framework of a processing step of the batch processing.

The upper limit depends on the segment size, the restrictions of the platform as well as from the maximum processing steps for each data set to be compared, and it is defined accordingly.

Thereby, a particularly reliable processing is ensured since no processing steps have to be repeated which, because of too large segmenting or packetting, result in exceeding the restrictions of the available resource and are interrupted thereby and are cancelled.

This method is particularly well applicable in case it is not a matter of time critical processes. By this method, data processing steps can be processed by and by in the background without the user being impaired thereby. For time critical processes, for example the immediate duplicate determination upon a new input of a data set through a user, a time optimized variation of the above method is used which requires only a fraction of the resources of a batch processing, thereby rendering a result within short time which is, possibly, only a preliminary result and is finally determined in a complete batch processing later on.

The user can either trigger the method himself, or it can be triggered automatically, An automatically triggering can occur, for example, whenever a new record is entered into the system. An automatic, periodical triggering is also conceivable, wherein the periods can be set by the user.

In a preferable embodiment, access to the data stored on a database is made possible through the platform. The data are essentially personal/business related data with attributes like name, turnover tax number, address, country and so on. These attributes may be set basically user specifically.

In a further advantageous embodiment, only data sets are subjected to the data processing which have been changed as to their content. For this purpose, the data sets are marked “changed” after processing their attributes. As only changed data sets are to be subjected to a segmenting, this leads to a basic reduction of the working effort which enlarges the processing speed and the reliability.

In particular, the data sets available for forming packets can be restricted such that only data sets are considered during the selection which match in at least one attribute to the data set/data sets contained in the segment. For example, such an attribute for the data set selection may be the country of the company location. These attributes can be set in a query prior to the segmenting in a variable way. The restriction to identical attributes proves to be particularly advantageous above all in the determination of duplicates and in the normalization of the data sets.

In a particularly advantageous embodiment, on the platform, a further database, a reference database, is made available which allows the aggregation and central management of the data: This is made thereby that from at least one further system, similar data as stored on the data processing unit accessible by the Internet, are stored in the referenced database of the platform. Also the data of the data processing unit accessible through the Internet are stored in this referenced database of the platform. This allows a user to centrally manage easily data with similar structures from different systems,

As in the case of different systems there is the possibility that single data sets are existing as duplicates and are easily differently updated, it is particularly useful to normalize and/or consolidate and/or aggregate in a further form the date in this reference database. The user has, thereby, the possibility to recognize and correct different data sets across systems. For consolidating differing data sets, the invention uses configurable rules.

In a further advantageous embodiment, the amount of operations to be carried out can be reduced thereby that the total number of data sets is grouped into clusters. For this purpose, at least one comparison parameter is defined whereby data sets are grouped in a cluster which match in the predefined comparison parameters or are in a similarity range which is, in particular, defined by a user. The segments and packets are only formed and processed with respect to the data sets existing in a cluster.

Thereby, a reduction of the data sets to be processed is resulting since the data sets of the segments of a cluster must not be processed anymore with packets of the remaining clusters. The processing speed can be put up by a multiple by defining clusters.

The processing speed is the larger the larger the number of clusters is selected. The cluster size is, in particular, selectable by the user: This can be defined through the number of the comparison parameters and the respective degree of similarity. The more similar the comparison parameters are supposed to be and the more comparison parameters are supposed to match and the higher the number of clusters is selected, the larger is, however, also the danger that an appropriate processing of a data set erroneously is not carried out,

Preferably, in the identification of duplicates where the processing of data includes a similarity comparison, clusters are formed. In particular in this case, the correlation of the comparison parameters to the parameters required in the similarity comparison is very high. Therefore, this results in a pronounced reduction of the processing time this minimal increased error rate.

The detection of duplicates can also be carried out successively in decreasing levels of acceleration. This reduces the required total number of operations with respect to a complete comparison and can achieve an extremely low error rate anyway:

Further advantages, features and applications of the present invention will become apparent form the following description in connection with the embodiments shown in the drawings:

In the description, the claims and the drawings the terms contained in the list of reference numbers below and the associated reference signs are used.

In the drawings:

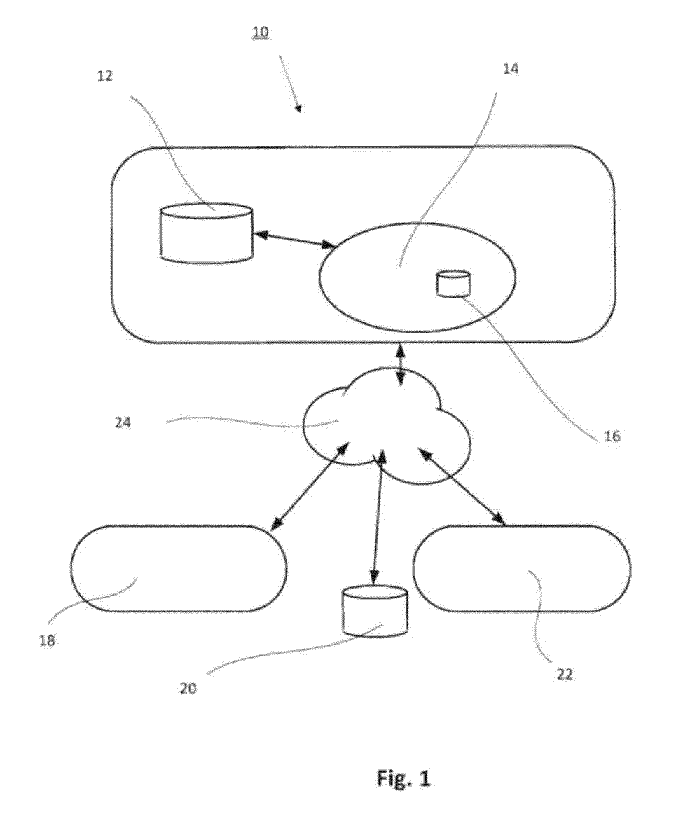

FIG. 1 is a schematic representation of the data processing environment; and

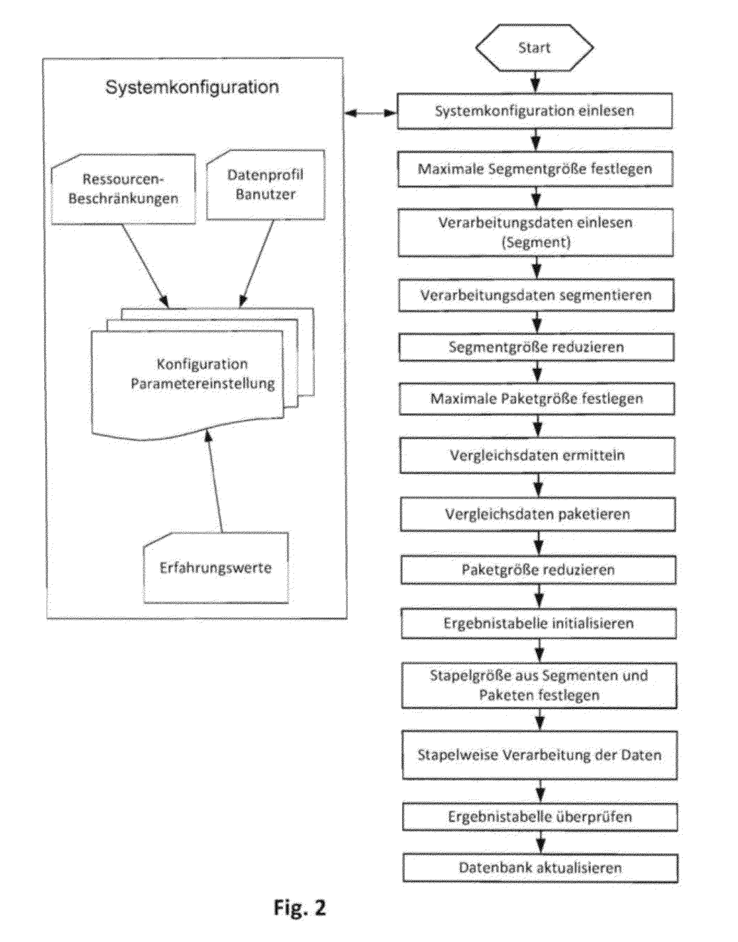

FIG. 2 is a flow chart of a sequential execution of an instruction list with the segmentation according to the invention.

FIG. 1 schematically shows a central cloud-data processing unit 10. The so called cloud-data processing unit 10 is connected by means of further data processing unit 18, 22 through the Internet 24. The central cloud-data processing unit 10 offers the required resources as well as a platform 14 by which, on a central cloud-database system 12, in particular data sets in a connected customer database, can be user specifically stored and processed. Therein, the platform offers basic functions by means of which a processing of the data sets of the database system 12 is made possible.

In this way, the data sets stored in the cloud-database system 12 can be read, managed and updated by its users with the aid of their data processing unit 18, 22. The data sets consist essentially out of the attributes name, address, country, telephone number and other contact data as well as key attributes,

Additionally, a further referenced database 16 is provided which allows the aggregation of the data from the cloud-database 17 with data of at least one further system 20. Because of this combination of different systems, it is likely that individual data sets are existing as duplicates and the same companies/persons are listed with differing addresses.

There are existing known methods for normalizing data sets, for determining duplicates and to consolidate the data sets. In particular with large enterprises, there is the problem that massive data have to be processed for this purpose.

Since the cloud-data processing unit 10 can offer only limited resources to a user since it is basically available to an arbitrary number of users and since it has to guarantee corresponding resources to all users for a continuous usage performance. This shared usage of the resources is called “multi-tenancy” wherein each user obtains access to its user specific data only.

In order to control the process utilization and to avoid overloading of the infrastructure of the cloud-data processing unit 10, restrictions on the execution of programs are imposed. Those can, in particular, exist in form of “Governor Limits”. Thus, for example the number of executable operations in a time period step is limited. A batch processing can, for example, be triggered once per hour wherein a working step of a batch processing sequence can be triggered every 2 seconds but is not allowed to comprise more than 10,000 operations.

For massive processing of data sets, they are grouped to segments, and exactly this segment is completely batch processed in a batch processing sequence, wherein the data sets of the segment are compared to the data sets of at least one packet.

For this purpose, a function for batch processing is made available from the platform 14, whereby complex processing and data processing adapted to be carried out over a long time period are basically possible by means of the segmenting of the data sets in combination with the offered batch processing,

The segment size and the packet size are determined, according to the invention, such that all provided data sets of the referenced database 16 can be completely processed or compared, respectively in a batch processing sequence with the available resources, and that sufficiently small segments and packets which are, however, as large as possible, are compiled. This method is described in FIG. 2 in more detail.

FIG. 2 is a flow chart which shows the method for segmenting and the final data processing.

In the present case, at first, the system configuration is read out and, depending therefrom, the number of the possible operations for each working step is evaluated which is delimited by the realities of the data processing unit due the presence of the Governor Limits of 10,000.

On the basis of the calculations and of a mass data test, it is predicted that, for a data set having 10 attributes in which only the attributes name and country are examined as to similarity of 96%, about 200 operations are required for a consolidation of a data set,

Accordingly, in this exemplary case, a maximum determined packet size of 50 data sets is resulting with a segment size of one data set.

In analogy to the determination of the packet size, the segment size is determined. For this purpose, however, other Governor Limits are set, for example the maximum list size or the maximum storage size. If it is only about a pure examination of an already existing database content, for the data sets which are made available for the formation of segments, only the data sets marked as changed are used, however, only so many data sets are read out at maximum as are predefined by the maximum segment size: The segment of changed data sets thus obtained, is subsequently optimized in order to further reduce the number of the required operations. If required, the segment size is further reduced in case special constellation is present in the segment which could lead to exceeding the Governor Limits.

Now all eligible comparative data sets are determined and optimized in order to further reduce the number of the required operations.

Subsequently, the packet size is selected such that all packets of data sets to be compared can he processed in one batch.

Subsequently, the tasks are processed in batches and the final list is updated. In case a Governor Limit is exceeded within a batch, the complete batch processing has to be completely interrupted.

When all batches are processed, the result is examined and, if necessary, corrected, and stored in the database. The batch processing is completed thereby and the total segment of data sets has been processed completely.

### LIST OF REFERENCE SIGNS

10 cloud-database equipment
12 cloud-database system
14 platform
16 reference database
18 data processing unit
20 database system
22 data processing unit
24 Internet

1-15. (canceled)

16. Computer implemented method for processing data on a data processing unit accessible through the Internet, comprising the steps of:
installing an application for processing of data on said data processing unit, said application being usable by a plurality of users;
evaluating and/or updating and/or adapting data sets which are stored on said data processing unit;
accessing, by a plurality of users, said Internet-accessible database system;
restricting access to said Internet-accessible database system according to the computational capacity of said data processing unit;
segmenting data to be processed based on predicting said computational capacity of said data processing unit in order to process working steps of a batch step, said segmented data includes data sets;
selecting said segment size and said data sets as large as possible based on available resources; and
processing, in a batch step, said segmented data sets, and processing working steps at predetermined times.

17. Method according to claim 16, wherein said data sets of said segments are compared with comparison data sets, and, said comparison data sets are grouped in packets.

18. Method according to claim 17, wherein said batch processing includes a step of selecting the largest whole number of possible data sets and packets which can be processed.

19. Method according to claim 16, wherein said step of selecting said segment size and/or said packet size includes the step of evaluating the number of attributes to be taken into account.

20. Method according to claim 17 wherein said segmentation and/or packetting considers only changed data sets.

21. Method according to claim 16 wherein said data processing comprises consolidation of said data sets.

22. Method according to claim 16 wherein said data processing comprises normalizing said data sets.

23. Method according to claim 17 wherein said data processing includes formation of said segments and/or said packets.

24. Method according to claim 1 herein boundary conditions for said segmentation are adjustable by the user.

25. Method according to claim 16 wherein said processing comprises a comparison of said data sets wherein a required degree of similarity for determining a match is adjustable.

26. Method according to the claim 16 wherein said application comprises a database (16).

27. Method according to claim 26, further comprising the steps of:
reading said data from a central database (12) of said data processing unit (10) and writing said data into database (16); and,
reading said data out of at least one external connected system (22), and, writing said data into said database (16).

28. Method according to claim 16 wherein:
said segments are restricted to data sets out of clusters;
said clusters are formed form the total number of data sets thereby that at least one comparison parameter and the similarity degree thereof is defined; and,
such data sets are grouped which fulfil this criterion.

29. Method according to claim 28 wherein said data sets of a segment and the comparison data sets of a packet are formed only out of said data sets of a cluster.

30. Method according to claim 29 wherein clusters are used for processing in the form of duplication detection.
